(19) United States
(12) Patent Application Publication
(10) Pub. No.: US 2007/0152117 A1
(43) Pub. Date: Jul. 5, 2007

(54) Viscoelastic Mounting Device

(76) Inventor: Randel Louis Byrd, Portland, OR (US)

Correspondence Address: QUICKPATENTS, INC., 32861 CALLE PERFECTO, SUITE A, SAN JUAN CAPISTRANO, CA, 92675, US

(21) Appl. No.: 11/619,094

(22) Filed: Jan. 2, 2007

Related U.S. Application Data
(60) Provisional application No. 60/756,459, filed on Jan. 4, 2006.

(51) Int. Cl. F16M 11/04

(52) U.S. Cl. 248/187.1

(57) ABSTRACT

An apparatus for selectively holding a device, such as a camera, to a surface is disclosed. An internal frame has at one end an attachment means, such as a threaded stud, for selectively attaching the device to the apparatus. The frame further includes a substantially circular flat base that has a first side and a second side. The flat base is substantially conformable to the shape of the surface. A longitudinal shaft is included that extends orthogonally from the first side of the base. A viscoelastic material is fixed about the internal frame and extends beyond a second end of the frame. The viscoelastic material is temporarily adhered to the frame and is capable of selectively adhering the apparatus to the surface. The viscoelastic material preferably includes an R.T.V.-type silicon-based compound, a dimethyl siloxane compound, a borosilicone rubber combination with silicone oil, a silicone polymer combination with boric oxide, or a combination thereof. As such, the viscoelastic material is able to temporarily adhere to most surfaces with enough strength to hold the apparatus and the device thereto, even against the force of gravity and in virtually any typical environmental temperature. At least one lateral frame member is included, projecting away from the longitudinal shaft for increasing the surface area of the frame to which the viscoelastic material adheres. An outer covering surrounds the viscoelastic material and the frame and serves as a barrier between the viscoelastic material and the device.

### CROSS-REFERENCE TO RELATED APPLICATIONS

This application claims the benefit of U.S. Provisional Patent Application 60/756,459, filed on Jan. 4, 2006, incorporated herein by reference.

### STATEMENT REGARDING FEDERALLY SPONSORED RESEARCH AND DEVELOPMENT

Not Applicable

### FIELD OF THE INVENTION

This invention relates to camera mounts, and more particularly to a viscoelastic mounting device for mounting a camera temporarily on a wide variety of surfaces.

### DISCUSSION OF RELATED ART

When taking a photo, there is almost always some camera or subject movement that can blur the image. Even under the best of circumstances, such bluring happens ever so slightly. To reduce blur caused by camera movement, especially when photographing in dim light or when planning to make large prints, a photogrpaher must support the camera to prevent movement as possible. In some cases, a porch railing, tree branch, or other fixed structure may provide additional support. In other cases, the photographer requires a tripod or monopod.

Technology changes things over time and one prominent change in the field of photography has been in the materials used to make tripods. The familiar aluminum tripod is now accompanied by carbon fiber models that are both much lighter and much more expensive. Carbon fiber tripods are up to 30% lighter than equivalent aluminum or alloy versions, yet retain the same strength, stability and durability. Support tubes of such tripods are made of long carbon fibers impregnated with epoxy resin under high pressure and temperature. The additional cost of carbon fiber is justifiable is if the photographer carries the tripod long distances or photograph in extremely cold temperatures where carbon fiber doesn't feel as cold to the touch. Still, such tripods constitutes additional weight and can be inconvenient on a long hike, for example.

There are hundreds of tripod models and even more accessories, so even fairly large camera store can only stock a limited selection of what is available. Smaller stores tend to stock inexpensive tripods because of their popularity. For quality tripods the photographer almost always has to find a large store in a metropolitan area or shop over the Internet. One difficulty in shopping for a tripod or other camera support is that such items often need to be evaluated first-hand. Buying on-line based solely on a photo and description often results in dissatisfaction when the product arrives.

When absolute sharpness in a photograph is desired, and the subject isn't prone to flight or moving erratically, nearly any mounting device is a beneficial, particularly when photo-blurring vibrations are reduced even more by using the camera's self-timer, remote control, or cable release. And, with the popularity of ever smaller digital cameras the advent of sending photos over the Internet, and the use of digital photos on websites such as eBay and others, consumers are becoming more and more capable of taking better pictures. Most professionals having been using tripods for years, however, as digital cameras and the Internet allow consumers to become more acquainted with taking high-quality pictures, a large market for a light-weight, portable, and easily transported camera supports, specially designed for digital cameras and other similar devices, has become evident.

There are essentially three currently used methods to support a camera or other similar device: suction cup devices, bean bag or similarly constructed devices, and traditional tripod-type devices. Suction cup devices and traditional tripod-type devices are widely known and are available in a wide range of sizes and including various features.

However, such devices do not allow convenient mounting of a camera on irregular surfaces, or non-horizontal surfaces. Bean bag-type devices are unstable and do not allow for secure positioning of the camera on sloped surfaces.

Other materials have not been adapted for uses involving the support of camera equipment or other similar devices. In particular, temporary adhesive viscoelastic compounds have been used as temporary fasteners to keep objects from moving such as preventing a picture frame from falling off the wall during an earthquake, (such as that material marketed as “Quake Secure! Earthquake Putty,” manufactured by Sunset Enterpirses, Ltd., of Thousand Oaks, Calif., www.gotputty.com).

One such temporary adhesive is disclosed in U.S. Pat. No. 6,325,885 to Harrison on Dec. 4, 2001 (incorporated in its entirety herein by reference) which discloses a pressure-sensitive adhesive based on a dimethyl polysiloxane gum for adhering porous and semi-porous substrates. The adhesive has thyrotrophic properties which permits the viscosity of the adhesive to breakdown when pressure from one substrate is exerted on another substrate which is in a horizontal positioning order to allow a temporary adhesion. The adhesive is transparent, has a consistency of a gel, and a viscosity range that controls the flow of the adhesive and provides a bond that can be broken by physical separation of the two substrates.

U.S. Pat. No. 5,566,031 to Meyr et al. on Oct. 15, 1996 (incorporated in its entirety herein by reference) discloses a silicone gel composed of cross linking two-part silicone rubbers causing vulcanization. The gel is used as a transparent sealing tape adhesive for electrical components which permits the sealing of two materials with very different coefficients of thermal expansions improving the adhesion strength due to the elasticity of the gel.

U.S. Pat. No. 5,473,005 to Columbus et al. on Dec. 5, 1995 (incorporated in its entirety herein by reference) discloses the use of an adhesive gel based on polyvinyl alcohol, which has thixotrophic characteristics for adhering porous and semi-porous substrates such as paper, cloth and wood.

U.S. Pat. No. 5,328,696 to Noel on Jul. 12, 1994 (incorporated in its entirety herein by reference) discloses hot-melt silicone pressure sensitive adhesive compositions containing waxes, silicate resins and silicone fluids. It was disclosed that the addition of an organic wax having a melting point between 30° C. and 150° C. decreased the dynamic viscosity of the adhesive at temperatures equal to or below 200° degrees C.

U.S. Pat. No. 4,460,371 to Abber on Jul. 17, 1984 (incorporated in its entirety herein by reference) provides a pressure sensitive adhesive formed from a crosslink polymerization of methyl/phenyl siloxane gum, dimethyl siloxane gum and apolysiloxane resin. The resulting product is suitable for adhering to a large number of surfaces and has particular utility as an adhesive between plastic film and human skin, demonstrating liquid permeability and release characteristics.

U.S. Pat. No. 4,016,328 to Horning on Apr. 5, 1977 (incorporated in its entirety herein by reference) discloses a pressure sensitive tape using a silicone resin, silicone gum and a curing agent to produce superior peel strengths. Such tape utilizes an admixture of silicone resin and a hydroxyl heat-cured octamethylcyclotetrasiloxane gum, or a chemically-cured dimethyl polysiloxane gum solubilized in xylene to form solutions between 55% to 65% solids. The performance of such an adhesive solution is based on its chemical interaction, whereby the dimethyl polysiloxane gum is “cured” and the adhesive solution is coated onto a two mil etched polytetrafluoropolyethylene film which acts as a carrier for the adhesive to be applied to a surface.

Certain advantages have been found with a composition based on the inherent adhesive properties of a form of elastomeric silicone polymer, R.T.V. a “Room Temperature Vulcanization” (curing without heat) silicon. Additionally due to its physical properties, no carrier is necessary for such an applied adhesive. Most R.T.V. cured silicone rubbers retain flexibility up to temperatures as high as 200° C., with some even withstanding brief exposure to 300° C. At the other end of the temperature scale, they are still completely flexible at −50° C., with special types able to withstand −100° C. Generally, such compounds' thermal conductivity allows insulation of electrical equipment without heat accumulation. Their electrical characteristics, especially their insulating resistance, dielectric strength and dissipation factor, are highly advantageous.

R.T.V. silicone rubbers are one-component, ready-to-use R.T.V. systems. They comprise polydimethylsiloxanes, cross linking agents, fillers, and auxiliaries. Cross linking is triggered by contact with atmospheric moisture and proceeds with the elimination of by-products. It therefore starts off at the surface with the formation of a film and gradually extends further and further into the rubber. The by-product, which is formed in small quantities, varies with the type of cross linking agent employed and may be an amine, acetic acid or a neutral compound, such as alcohol.

R.T.V. silicone rubbers are the ideal solution to a large number of sealing, bonding and coating problems. They have excellent resistance to weathering and ageing because of their unique chemical properties. Special additives ensure that RTV-1 silicone rubbers can also withstand extremely high and low temperatures.

Typical applications in which R.T.V. silicon rubbers are effective in nearly all sealing, bonding and coating applications. As a result, they are used extensively in the automotive, construction, electrical, electronic, moulds, electronics, mechanical and plant engineering and healthcare devices.

Viscoelastic silicone compounds and elastomers have been known and used since at least the 1940s. For example, U.S. Pat. No. 2,431,878, issued Dec. 2, 1947 to McGregor, teaches a combination of a silicone elastomer with a filling agent and referred to as “bouncing putty.” Silicone containing polymers known as bouncing putties are well described in the patent literature, beginning with U.S. Pat. No. 2,541,851, issued Feb. 13, 1951 to Wright, and including U.S. Pat. No. 3,677,997 to Kaiser on Jul. 18, 1972.

Viscoelastic putties are useful in several applications: (i) as toys such as Silly Putty™ and Thinking Putty™, (ii) as therapeutic exercise aids for hand exercises, (iii) as methods for providing stabilization to chairs or wall hangings in such products as Earthquake Putty™, and (iv) as energy absorbing materials employed in systems designed for the protection of humans from damage by impact, often referred to as impact protection systems.

Viscoelastic silicone polymer bouncing putties are sold as a novelty by Crazy Aaron Enterprises, Inc, Narberth, Pa., (www.puttyworld.com) and by Binney & Smith, Easton, Pa., (www.sillyputty.com). Viscoelastic putties can be prepared with various flow resistances and adhesiveness, from very soft to very resistant, and from very dry to very sticky. Resistant, sticky viscoelastic silicone polymers can provide a useful material in their ability to temporarily adhere to various geometric shapes and provide a temporary malleable mount, certainly long enough to take a picture or capture a video.

Another, useful putty base is a dimethylboropolysiloxane compound or borosilicone rubber, often a combination of boric acid with silols and reinforcing silicas.

Workers in the art recognized as early as the 1940's that addition of alternate fillers, thickening or thinning agents and other compounds, allowed control of a wide variety of the putties properties. For example, a typical viscoelastic silicone putty includes oleic acid as a softener, glycerine as a bounce enhancer and silica quartz crystalline, as a moisture scavenger for regulating adhesiveness.

Polydimethylsiloxane, a silicone oil, can modify the consistency of viscoelastic polymer putties from soft to rock hardness. The intrinsic density of the mixture may vary between about 0.95 (soft) and 1.6 (very hard) providing a desired adhesiveness and malleability.

Unlike conventional putty or caulking products, bouncing putties do not dry out, harden or produce permanent bonds. In addition, within minutes after molding viscoelastic compounds into a desired shape, the compounds flow or collapse downwardly like viscous fluids. This characteristic would normally render bouncing putties unacceptable for a mounting device.

U.S. Pat. No. 5,693,689 (incorporated in its entirety herein by reference) issued to Gibbon on Dec. 2, 1997, discloses a therapeutic exercise kit of borosiloxane putty and/or siloxane putty. Therapeutic exercise putty masses are formed of a high-plasticity, silicone-based composition.

U.S. Patent Application 20050250620 (incorporated in its entirety herein by reference) issued to Minuto et al. on Nov. 10, 2005, sets forth a therapeutic exercise, comprising a silicone putty and certain pigments which are incorporated into a putty, such as bouncing putty. The putty is used for therapeutic purposes, such as exercising one's hand.

U.S. Pat. No. 5,607,993 (incorporated in its entirety herein by reference) issued to Christy on Mar. 4, 1997, sets forth a low-density bouncing putty comprising a dimethylboropolysiloxane compound or borosilicone rubber, typically in a combination with boric acid, reinforcing silicas, polarity modifiers such as glycerine, thinning agents and pigmentations.

U.S. Pat. No. 5,165,636 (incorporated in its entirety herein by reference) issued to Grissom on Nov. 24, 1992, discloses a stabilizing support terminus which includes a silicon based, high viscoelastic compound encapsulated in a vinyl coating, having a shape retaining memory that when pressure is placed on the encapsulation, it will slowly change shape to meet the contour of the surface on which it rests.

U.S. Pat. No. 5,604,998 (incorporated in its entirety herein by reference) issued to Kita on Feb. 25, 1997, discloses a bouncing putty-containing pad, positioned on an inner surface of said reinforcing, for holding and stabilizing a heel of a wearer. The reinforcing element is a cuplike stabilizer or a heel counter. The pad may be comprised of a foam impregnated with bouncing putty.

U.S. Patent Application 2005/0037189 (incorporated in its entirety herein by reference) issued to Palmer et al. on Feb. 17, 2005, discloses a self-supporting energy absorbing composite, comprising a solid foamed synthetic polymer matrix and a polymer-based dilatant. In one preferred embodiment, the dilatant compound is selected from silicone polymer-based materials exhibiting dilatant characteristics, whereby the silicone polymer is preferably selected from borated silicone polymers.

U.S. Pat. No. 5,042,765 (incorporated in its entirety herein by reference) issued to Widerstrom on Aug. 27, 1991, discloses that a self adjusting shim device has an elastic bladder formed of resilient material filled with bouncing putty. The bouncing putty filler will deform slowly under the slightest force like a highly viscous liquid, where the bladder is filled with the substance known as bouncing putty and whereby the bouncing putty is a solid elastic product of a reaction between a silicon oil and a compound of boron, such as boric acid.

While the aforementioned inventions all exhibit some desirable qualities of modeling compounds, stabilization devices, orthopedic aids and novelty toys, such as the ability to bounce, mold, form, shape, stabilize, while retaining their flexibility, pliability, and elasticity, they do not solve the problems associated with this invention. It is therefore, highly desirable to provide a mounting device exhibiting all of these characteristics and more. In particular, it is also imperative to provide a mounting compound with the inherent utility and usability features of many of the inventions mentioned above, but adapted to the use of the present invention.

While the inventors have disclosed silicone putty as the deformable material, other materials having the consistency and above noted properties of bouncing putties, and which are classified as semisolid or viscoelastic materials, can also be used, as long as they exhibit similar characteristics as required in the invention.

Accordingly, it is the objective of the present invention to provide an improved mounting device utilizing a viscoelastic compound that is highly malleable and pliable which can be molded to a wide variety of geometric shapes. Such prior-art viscoelastic compounds and materials have not been adapted to solve the problem of securing cameras or similar devices as described herein. Further, such elastic solid viscoelastic materials alone are unable to adequately perform in such a capacity. What is needed therefore, is a new configuration of holding device for securely mounting a camera or similar device with a viscoelastic material as a universal, temporary adhesive. The present invention accomplishes these objectives.

### SUMMARY OF THE INVENTION

The present device is an apparatus for selectively holding a device, such as a camera, or the like, to a surface. An internal frame is comprised of a rigid or semi-rigid material having at one end an attachment means for selectively attaching the device to the apparatus. The attachment means may be, for example, a threaded stud as typically found on conventional tripods and other standard camera mounts. The frame preferably further includes a substantially circular flat base that has a first side and a second side. The flat base may be flexible and substantially conformable to the shape of the surface. A longitudinal shaft is preferably included that extends substantially orthogonally from the first side of the base.

A viscoelastic material is fixed about the internal frame and extends beyond a second end of the frame. The viscoelastic material is temporarily adhered to the frame and is capable of selectively adhering the apparatus to the surface. The viscoelastic material preferably includes an R.T.V.-type silicon-based compound, a dimethyl siloxane compound, a borosilicone rubber combination with silicone oil, a silicone polymer combination with boric oxide, or a combination thereof, for example. As such, the viscoelastic material is able to temporarily adhere to most surfaces with enough strength to hold the apparatus and the device thereto, even against the force of gravity and in virtually any typical environmental temperature. The viscoelastic material is moldable, stretchable, pliable, and bendable, allowing it to conform to surfaces of nearly any shape, contour, or texture.

At least one lateral frame member may be included, projecting away from the longitudinal shaft for increasing the surface area of the frame to which the viscoelastic material adheres. As such, the adhesion between the viscoelastic material and the frame is increased.

An outer covering may be further included, the outer covering surrounding the viscoelastic material and the frame. The outer covering may include textile components, elastomeric or rubber components, vinyl material, neoprene, or any other flexible membrane, in various combinations, provided that the outer covering serves as a barrier between the viscoelastic material, and the device and other surrounding items.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a side elevational view of an internal frame of the present invention;

FIG. 2 is a top plan view of the internal frame of the present invention;

FIG. 3 is a perspective view of the internal frame of the present invention;

FIG. 4 is a side elevational view of an alternate embodiment of the internal frame of the present invention;

FIG. 5 is a cross-sectional view of the invention, taken generally along lines 5-5 of FIG. 2;

FIG. 6 is a perspective view of the invention as mounted to a curved surface;

FIG. 7 is a perspective view of the invention as mounted to a flat horizontal surface and with a camera mounted thereto;

FIG. 8 is a perspective view of the invention as mounted to a flat vertical surface and with a camera mounted thereto; and

FIG. 9 is a perspective view of the invention as mounted upside-down to a horizontal surface and with a camera mounted thereto.

### DETAILED DESCRIPTION OF THE PREFERRED EMBODIMENT

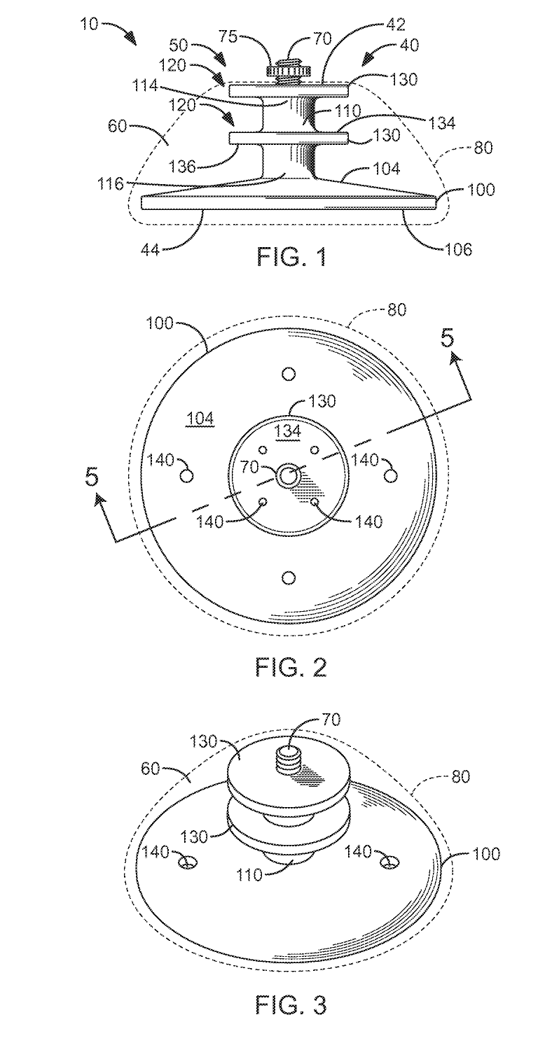

FIGS. 1 and 6 illustrate an apparatus 10 for selectively holding a device 20, such as a camera, or the like, to a surface 30. The device 20 may further be a video camera, a tape measure, a cellular phone, an MP3 player, a microphone, a reading light, speakers, a storage container such as for pencils, a GPS device, a computer monitor, a toy, a tool, a vehicle instrument, a gun, a telescope, binoculars, or other devices (not shown) that may be required to be mounted temporarily to a convenient location on the surface 30.

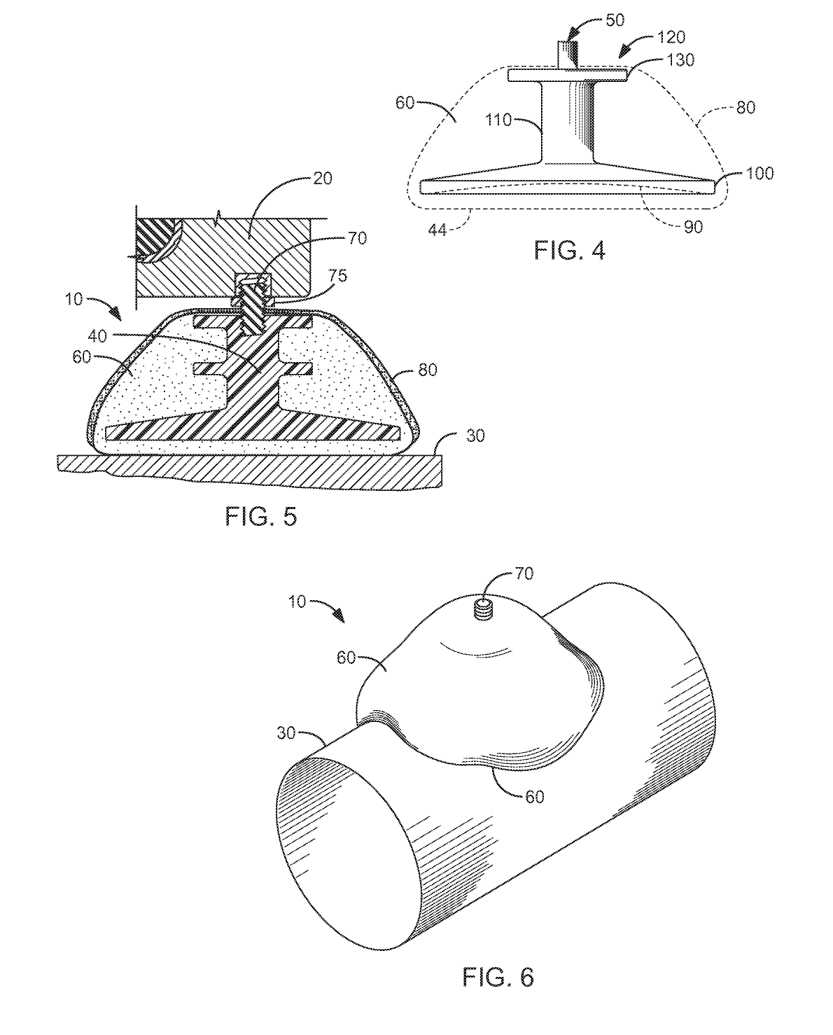

An internal frame 40 is comprised of a rigid or semi-rigid material having at one end 42 an attachment means 50 for selectively attaching the device 20 to the apparatus 10. The attachment means 50 may be, for example, a threaded stud 70 (FIG. 3) that includes a locking nut 75 (FIG. 1), such as is typically found on conventional tripods and other standard camera mounts. As such, the device 20 may be threaded onto the threaded stud 70 and locked into position by the locking nut 75 (FIG. 5). Alternately, as illustrated in FIG. 4, the attachment means 50 may be a non-threaded stud that is mounted to or formed integrally with the device 20. The attachment means 50 clearly may also include swivel heads, ball heads, quick-release mounts, hook-and-loop type fastener mounts, or other attachment means as is known in the art (not shown).

The frame 40 preferably further includes a substantially circular flat base 100 that has a first side 104 and a second side 106 (FIG. 1), the second side 106 forming the second end 44 of the frame 40. The flat base may be flexible and substantially conformable to the shape of the surface 30, such as in FIG. 6. The second end 44 of the frame 40, that is, the second side 106 of the flat base 100, may further include a concave portion 90 (FIG. 4) for further aiding the apparatus 10 in conforming to the shape of a curved surface 30, such as a handrail, or the like. A longitudinal shaft 110 is further included that extends substantially orthogonally from the first side 104 of the base 100, a first end 114 of the shaft 110 forming the first end 42 of the frame 40. A second end 106 of the shaft 110 is fixed to the first side 104 of the flat base 100.

A viscoelastic material 60 is fixed about the internal frame 40 and extends beyond a second end 44 of the frame 40 (FIG. 1). The viscoelastic material 60 is temporarily adhered to the frame 40 and is capable of selectively adhering the apparatus 10 to the surface 30 (FIGS. 5, 7, 8 & 9). The viscoelastic material 60 preferably includes an R.T.V.-type silicon-based compound, a dimethyl siloxane compound, a borosilicone rubber combination with silicone oil, a silicone polymer combination with boric oxide, or a combination thereof, for example. As such, the viscoelastic material 60 is able to temporarily adhere to most surfaces 30, even irregular surfaces 30, with enough strength to hold the apparatus 10 and the device 20 thereto, even against the force of gravity and in virtually any typical environmental temperature. Further, the viscoelastic material 60 adheres even more strongly to itself, such that when the apparatus 10 is removed from the surface 30, such as by pulling the apparatus 10 away from the surface 30, the viscoelastic material 60 is completely removed from the surface 30 and remains with the frame 40 of the apparatus 10. Further, substantially all of the viscoelastic material 60 is removed such that little to no residue thereof remains on the surface 30. The viscoelastic material 60 is moldable, stretchable, pliable, and bendable, allowing it to conform to surfaces 30 of nearly any shape, contour, or texture.

Some examples of preferred formulations of the viscoelastic material follow:

### EXAMPLE 1

“Thinking Putty,” which can be purchased in many colors from Crazy Aaron Enterprises, Inc., 125 Conway Ave, Narberth, Pa., (www.puttyworld.com), may be used as the viscoelastic material 60 in the present invention, and as such provides a medium hold viscoelastic material 60.

### EXAMPLE 2

65.0% Dimethyl Siloxane, hydroxy-terminated polymers with boric acid
17.0% Amorphous Silica
09.0% Thickener (preferably Thixotrol ST)
04.0% Polydimethylsiloxane
01.0% Decamethyl cyclopentasiloxane
01.0% Glycerine

### EXAMPLE 3

82.4% Dow-Corning silicone polymer
04.5% Boric oxide
01.7% Glycerine (used as a polarity modifier to regulate softness)
01.7% Ferric stearate
00.2% Oleic acid (used as a thinning agent)

### EXAMPLE 4

### Viscoelastic Material 60 that Provides a Light to Strong Putty

60.0-85.0%-Dimethyl Siloxane, hydroxy-terminated polymers with boric acid
15.0-40.0% Quartz
07.0-13.0 Thickener
03.0-07.0% Polydimethylsiloxane
01.0-05.0% Titanium dioxide
01.0-05.0% Decamethylcyclopentasiloxane
01.0-05.0% Glycerine
01.0-05.0% Decamethyl cyclopentasiloxane

### EXAMPLE 5

### Viscoelastic Material 60 that Provides a Light to Strong Putty

60.0-85.0% Q2 3233 (Dow Corning)
10.0-30.0% PM 6717 Glass Microspheres
05.0-25.0% 10 cs Silicone Oil
01.0-10.0% 50 cs Silicone Oil
01.0-05.0% 350 cs Silicone oil

### EXAMPLE 6

### Viscoelastic Material 60 that Provides a Light to Strong Putty

40.0%-55.0% Borosilicone
00.0%-06.0% 5 Micron Silica
00.0%-06.0% Syloid Zn-1
20.0%-35.0% 10 cs Silicone oil
01.0%-05.0% 350 cs Silicone oil
00.9%-03.0% Glycerine

The preferred formulation of the viscoelastic material 60 is a sticky substance that is puttylike at low viscosities (low resistance to flow) with a reasonable working life of at least several years. Further, the preferred formulation has an ability to adhere to various geometric shapes. The addition of each of the following components may affect the balance of properties in the resulting viscoelastic material 60, including but not limited to, stickiness, flexibility, viscosity, pliability, flow resistance, working life and density. Depending on the type of device 20 requiring mounting and the surface 30 that provides support, various properties and viscoelastic material 60 may be used with the present invention. Pigmentation may also be included in the formulations to the extent desired.
Silica—Removal of silica (a reinforcing filler) reduces density but also reduces moisture capacity. Adding freely ground silica improves moisture capacity but increases density.
Microspheres—Adding microspheres reduces density and increases resistance to flow but also reduces working life of the viscoelastic material 60. Adding microspheres generally necessitates adding additional thinning oil to maintain desirable properties. If too many microspheres are added to maintain the density, then the volume percent of the borosilicone base is decreased. If that volume percent drops below a critical level it will degrade the plasticity and handling characteristics of the viscoelastic material 60.
Moisture scavengers—Adding moisture scavenger will increase the moisture capacity of the viscoelastic material 60. However, since both sieves and silica gel are relatively dense (about 2 g/cc), addition of a large amount of moisture scavenger may necessitate adding additional density-reducing fillers to maintain the desired viscoelastic material 60 density.

Turning now to mechanical aspects of the invention, in the preferred embodiment of the apparatus 10, at least one lateral frame member 120 projects away from the longitudinal shaft 110 for increasing the surface area of the frame 40 to which the viscoelastic material 60 adheres. As such, the adhesion between the viscoelastic material 60 and the frame 40 is increased. Each lateral frame member 120 may take the form of a ring 130, for example, projecting substantially orthogonally to the longitudinal shaft 110 and fixed thereto (FIGS. 1 and 3). To further secure the viscoelastic material 60 to the frame 40, the flat base 100 may further include at least one aperture 140 formed therethrough between the first and second sides 104, 106 thereof (FIGS. 2 and 3). Similarly, each ring 130 may further include at least one aperture 140 formed therethrough between the first and second sides 134, 136 thereof (FIG. 2). An adhesive (not shown) may also be introduced between the viscoelastic material 60 and the frame 40 for increasing the adhesion therebetween.

Clearly the base 100 may be any shape other than circular as is shown in FIG. 2. For example, the base 100 may take the form of a V, square, ellipse, oval, rectangle, arch, or the like (not shown). Similarly, each lateral frame member may assume similar non-circular shapes (not shown). In the simplest embodiment of the invention (not shown), the frame 40 consists of the base 100, the first side 104 of the base 100 constituting the one end 42 of the frame 40, and the second side 106 of the base 100 constituting the second end 44 of the frame 40.

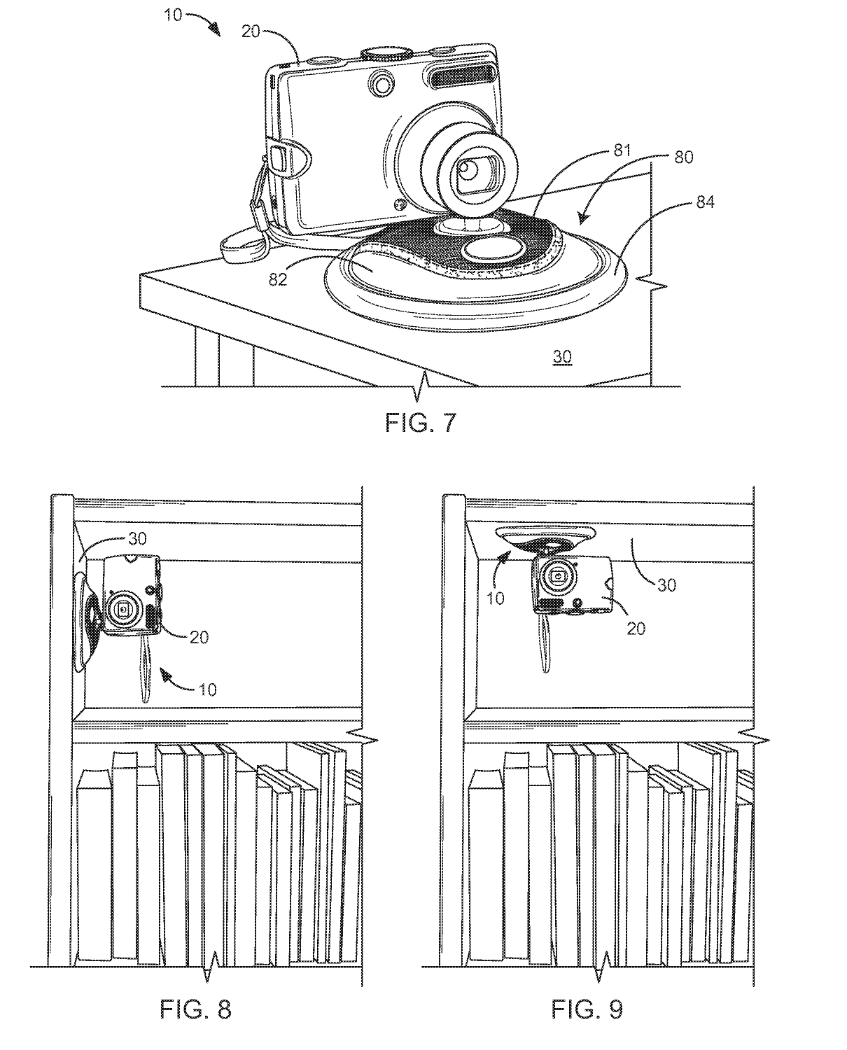

An outer covering 80 may be further included, the outer covering 80 surrounding the viscoelastic material 60 and the frame 40 between substantially the first and second ends 42, 44 of the frame 40 (FIG. 5). The outer covering 80 may include textile components 81 (FIG. 7), elastomeric or rubber components 84, and vinyl material 82, neoprene (not shown), or any other flexible membrane, in various combinations, provided that the outer covering 80 serves as a barrier between the viscoelastic material 60, and the device 20 and other surrounding items. Further, the outer covering 80 preferably substantially is sealed against impregnation thereof by the viscoelastic material 60 over time.

While a particular form of the invention has been illustrated and described, it will be apparent that various modifications can be made without departing from the spirit and scope of the invention. For example, the exact formulation of the viscoelastic material 60 may be modified as new compounds are discovered, provided that the viscoelastic material 60 provides the desired properties herein described. Further, the exact shape of the apparatus 10 may be modified in a number of different ways, other than those described and illustrated, yet still function as herein described. Accordingly, it is not intended that the invention be limited, except as by the appended claims.

What is claimed is:

1. An apparatus for selectively holding a device to a surface, the apparatus comprising:
an internal frame having an attachment means at one end for selectively attaching the device to the apparatus; and
a viscoelastic material fixed about the internal frame and extending beyond a second end of the frame, the viscoelastic material temporarily adhered to the frame and capable of selectively adhering the apparatus to the surface.

2. The apparatus of claim 1 wherein the attachment means is a threaded stud.

3. The apparatus of claim 2 further including a threaded locking nut, the nut being threaded to the stud.

4. The apparatus of claim 1 further including an outer covering surrounding the viscoelastic material and the frame between substantially the first and second ends of the frame.

5. The apparatus of claim 1 wherein the second end of the frame includes a concave portion.

6. The apparatus of claim 1 wherein the frame includes a substantially flat base, the flat base including a first side and a second side, the second side of the base forming the second end of the frame.

7. The apparatus of claim 6 wherein the frame further includes a longitudinal shaft extending substantially orthogonally from the first side of the base, a first end of the shaft forming the first end of the frame, a second end of the shaft fixed to the first side of the flat base.

8. The apparatus of claim 7 further including at least one lateral frame member projecting away from the longitudinal shaft, whereby each lateral frame member increases the surface area of the frame to which the viscoelastic material adheres, thereby increasing the adhesion between the viscoelastic material and the frame.

9. The apparatus of claim 8 wherein each lateral frame member is in the form of a ring, each ring projecting substantially orthogonally to the longitudinal shaft and fixed along the longitudinal shaft.

10. The apparatus of claim 6 wherein the flat base further includes at least one aperture formed between the first and second sides of the flat base, whereby the viscoelastic material may be introduced into each aperture for further securing the viscoelastic material to the frame.

11. The apparatus of claim 9 wherein at least one ring further includes at least one aperture formed between a first and second sides thereof, whereby the viscoelastic material may be introduced into each aperture for further securing the viscoelastic material to the frame.

12. The apparatus of claim 6 wherein the flat base is flexible and substantially conformable to the shape of the surface.

13. The apparatus of claim 1 wherein the viscoelastic material includes an R.T.V.-type silicon-based compound.

14. The apparatus of claim 1 wherein the viscoelastic material includes a dimethyl Siloxane compound.

15. The apparatus of claim 1 wherein the viscoelastic material includes a borosilicone rubber combination with silicone oil.

16. The apparatus of claim 1 wherein the viscoelastic material is a silicone polymer combination with boric oxide.
